(19) United States
(12) Patent Application Publication
(10) Pub. No.: US 2020/0285639 A1
(43) Pub. Date: Sep. 10, 2020

(54) APPARATUS AND METHOD TO ISOLATE VECTORS IN AN ARBITRARILY LARGE N-SPACE

(71) Applicant: AT&T Intellectual Property I, L.P., Atlanta, GA (US)

(72) Inventors: Sheldon Kent Meredith, Roswell, GA (US); William C. Cottrill, Canton, GA (US); Yevgeniy Puzyrev, Cumming, GA (US)

(73) Assignee: AT&T Intellectual Property I, L.P., Atlanta, GA (US)

(21) Appl. No.: 16/292,509

(22) Filed: Mar. 5, 2019

(51) Int. Cl. G06F 16/2453

(52) U.S. Cl. CPC G06F 16/24537

(57) ABSTRACT

Aspects of the subject disclosure may include, for example, obtaining a first vector comprising a first plurality of parameters, determining a vector difference between the first plurality of parameters and a second plurality of parameters of a second vector, responsive to the determining, computing a first weighted vector distance based on the vector difference, providing a first representation of the first weighted vector distance to at least one bus, obtaining a second representation of a second weighted vector distance from the at least one bus, comparing the second representation of the second weighted vector distance to the first representation of the first weighted vector distance, and responsive to determining that the second representation of the second weighted vector distance matches the first representation of the first weighted vector distance based on the comparing, setting a first indicator to indicate a first match. Other embodiments are disclosed.

### FIELD OF THE DISCLOSURE

The subject disclosure relates to an apparatus and method to isolate vectors in an arbitrarily large n-space.

### BACKGROUND

As the use of networks and devices continues to increase, it can be difficult to find content of interest. For example, finding such content as part of a search involves sorting input data/parameters of the search; this is easy to do in a single dimension, but has no canonical solution for many dimensions.

Databases have been utilized in terms of locating data because they incorporate indexing of the data. While generally fast in terms of returning results, the indexed-based approach is premised on an assumption that there will be an exact match/hit in the database. In practical applications, with a large number of input parameters/data points involved, rarely will there be an exact match/hit. Consequently, for applications requiring any substantial degree of sophistication/accuracy, the database approach is infeasible (e.g., in all but the rarest of cases, the database approach will fail to return an exact match/hit).

If the search requires a high-level of sophistication/accuracy, then linear searching may be performed. As part of linear searching, the closest match (or number of closest matches) to a set of input parameters is obtained. While linear searching offers greater flexibility relative to the database/indexed approach discussed above in terms of actually obtaining a result, linear searching takes significantly longer to execute/complete. For example, it may take large computing systems multiple weeks to find or converge on a result in applications incorporating trillions of data points/parameters. Such a long time delay/lag is unacceptable in many applications.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C depicts a vector composed of parameters that is stored by a slave processor in accordance with various aspects described herein.

FIG. 2D depicts a search vector composed of parameters in accordance with various aspects described herein.

FIG. 2E depicts a parametric weight vector in accordance with various aspects described herein.

FIG. 2F depicts an illustrative embodiment of a user device in accordance with aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for isolating a vector of interest amongst a set of vectors. A vector of interest may correspond to a vector that is within a threshold distance of an input vector. In some embodiments, the threshold distance may be selected such that the vector of interest is identified as the closest match to the input vector. Other embodiments are described in the subject disclosure.

One or more aspects of the subject disclosure include computing in parallel, by each processor of a plurality of processors, a vector distance between a first input vector and a second vector that is stored by the processor, resulting in a plurality of vector distances. A vector distance included in the plurality of vector distances that is the least may be identified. Responsive to the identification of the vector distance that is the least, a determination/detection may be performed by each of the processors in terms of whether the vector distance computed by the processor matches/corresponds to the vector distance that is the least. Responsive to that determination, a processor may report, e.g., an identification of the processor when the processor detects such a match.

One or more aspects of the subject disclosure include converting a distance (e.g., a vector distance) to a voltage. In some embodiments, the conversion of distance to voltage may include an inversion, such that a smallest distance may correspond to a largest voltage. The voltage generated by a given processor may be reported/output on a bus (e.g., a common bus). The bus may be pulled up to the highest voltage presented by a plurality of processors.

One or more aspects of the subject disclosure include a reporting, by one or more processors, of the existence of a vector stored by a respective processor of the one or more processors that is within a threshold distance of an input vector. Where multiple processors store such a vector, the processors may report the existence of the same in order/sequence.

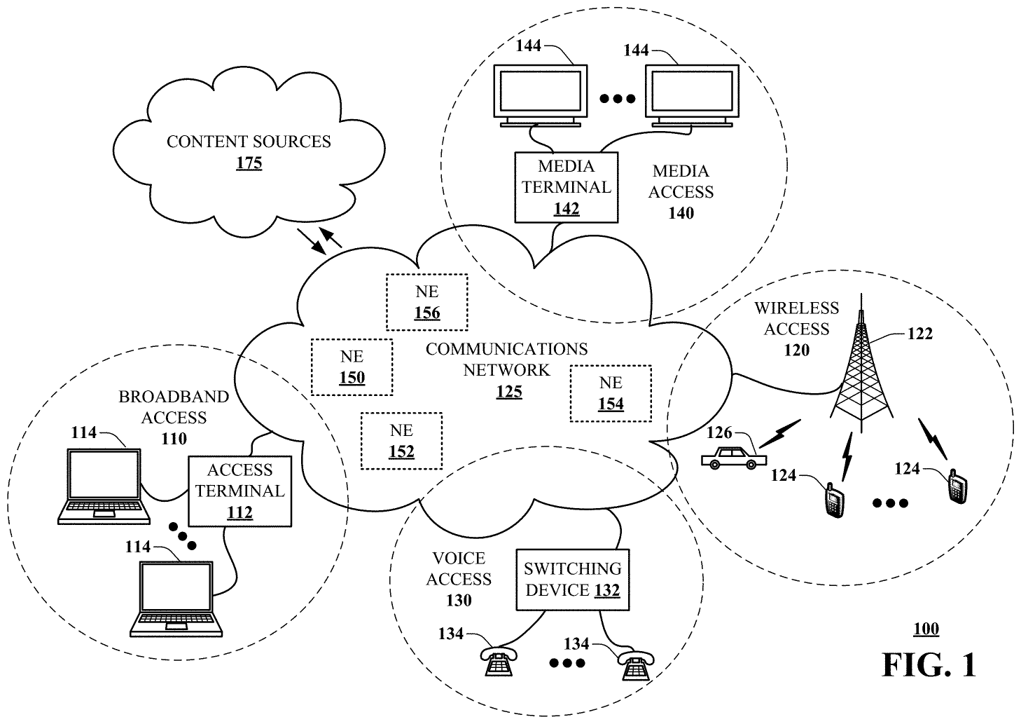

Referring now to FIG. 1, a block diagram is shown illustrating an example, non-limiting embodiment of a communications network 100 in accordance with various aspects described herein. For example, communications network 100 can facilitate in whole or in part identifying a vector included in a set of vectors that is within a threshold distance of an input vector. In some embodiments, the threshold distance may be selected such that the vector included in the set of vectors is a closest match to the input vector.

Referring back to FIG. 1, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

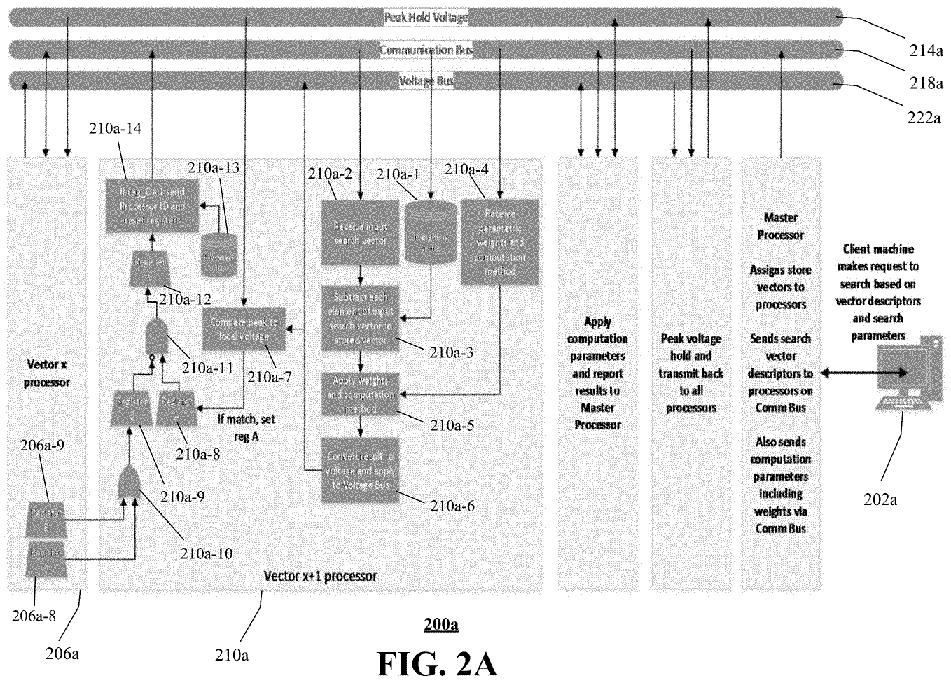

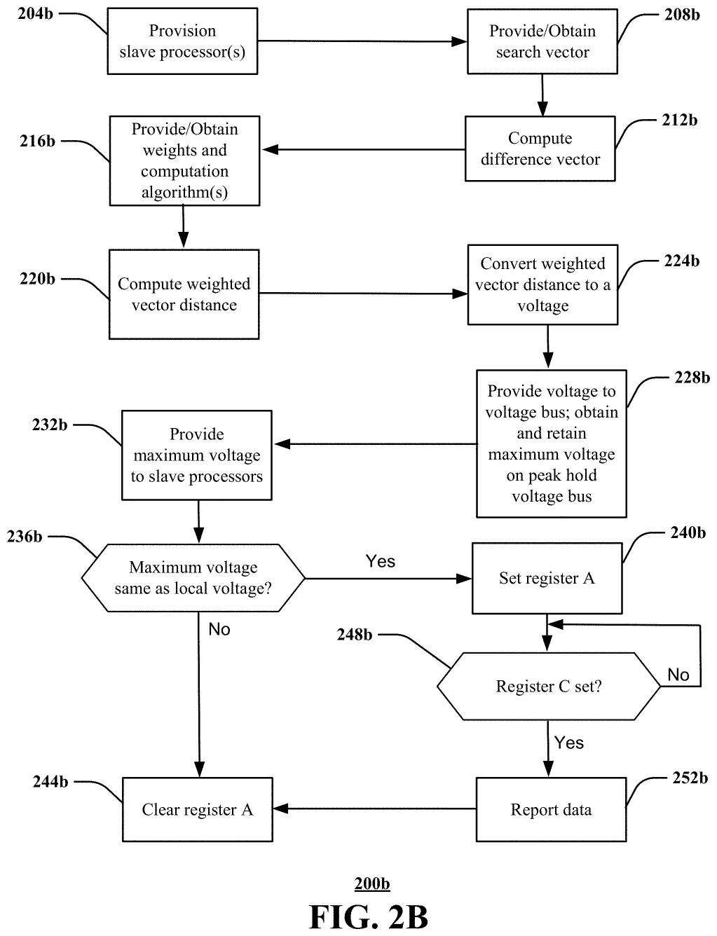

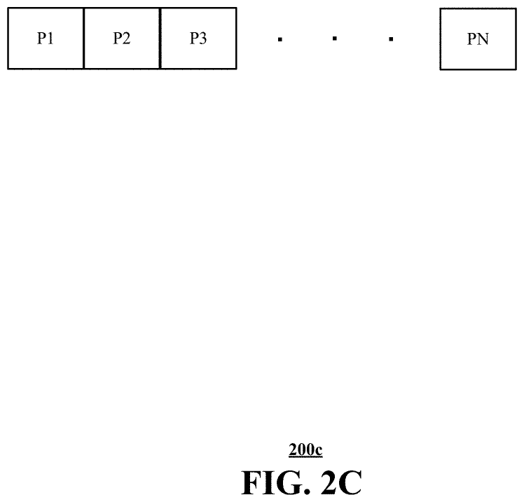

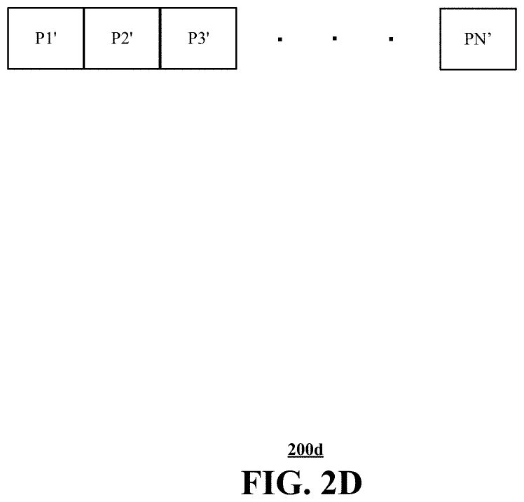

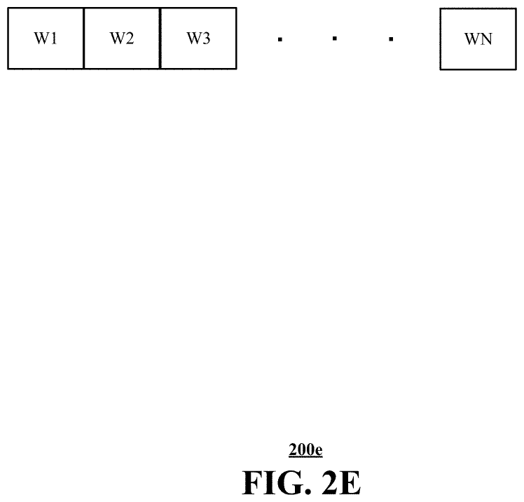

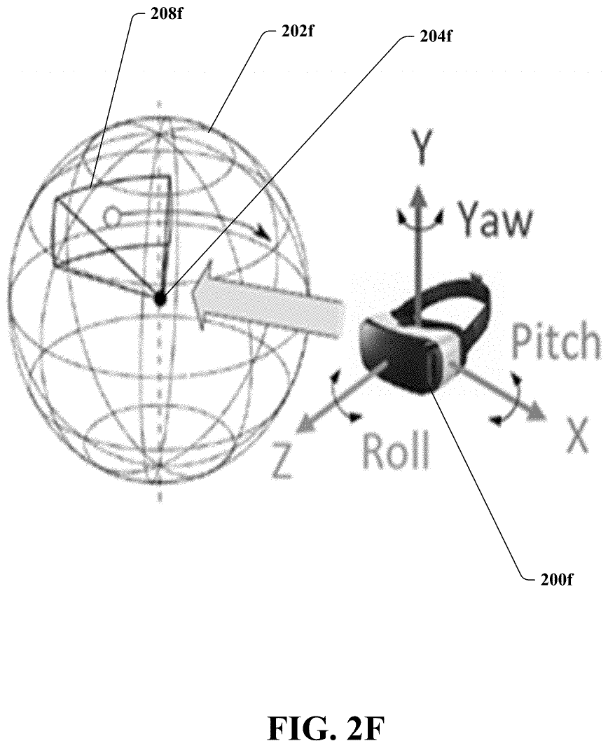

FIG. 2A is a block diagram illustrating an example, non-limiting embodiment of a system 200a. The system 200a may function within the communication network of FIG. 1 in accordance with various aspects described herein. The system 200a may include a master processor 202a, one or more slave/secondary processors (as exemplified by the processors 206a and 210a), a peak hold voltage bus/circuit 214a, a communication bus 218a, and a voltage bus 222a.

While two slave processors (e.g., the slave processor 206a and the slave processor 210a) are shown in FIG. 2A, in many embodiments the number of slave processors that are included will be significantly larger. Also, while three buses (e.g., buses 214a-222a) are shown in FIG. 2A, aspects of the disclosure may be incorporated in conjunction with one or more buses. As used herein, a bus may refer to, or be composed of, one or more conductors, wires, etc. A bus may include any type of transmission medium, including for example air. In this respect, communications (e.g., exchanges of data, status information, etc.) over the bus(es) may include wired/wireline and/or wireless communications.

In some embodiments, the master processor 202a and/or the slave processors 206a and 210a may be separate/discrete entities with respect to one another. For example, the processors 202a-210a may be packaged in separate housings. Alternatively, at least two of the processors 202a-210a may be included within a common packaging/housing. In some embodiments, at least two of the processors 202a-210a may be implemented as separate threads that may be executed by a common processor/processing core. Combinations of the foregoing (in terms of, e.g., packaging and/or implementation) may be used in some embodiments.

For the sake of convenience, the operation of the system 200a of FIG. 2A is described below in conjunction with the method 200b of FIG. 2B. One skilled in the art will appreciate, based on a review of this disclosure, that aspects of the system 200a may be operated/executed in accordance with methods that are different from the method 200b. Similarly, aspects of the method 200b may be executed in accordance with systems that are different from the system 200a.

In block 204b, one or more slave processors may be provisioned. For example, assuming that a new entry (e.g., new content) or a modified entry (e.g., modified content) is being made available in the system 200a, the master processor 202a may assign the entry to a particular slave processor (e.g., the slave processor 210a) via the communication bus 218a as part of block 204b. The entry may take the form of a vector composed of a number of parameters. Briefly referring to FIG. 2C, an exemplary vector 200c is shown composed of parameters P1, P2, P3, . . . PN, where N represents the number/count of parameters.

Each of the parameters P1, P2, P3, . . . PN may correspond to a separate/distinct/independent dimension of the vector for reasons that will become clearer below. Each of the parameters P1, P2, P3, . . . PN may have a value within a range of values for the respective parameter.

As part of block 204b, the slave processor 210a may store the assigned vector 200c in a storage device 210a-1 (e.g., a computer readable medium, a memory, etc.) of the slave processor 210a.

In block 208b, the master processor 202a may provide a search/input vector to the communication bus 218a. For example, and briefly referring to FIG. 2D, an exemplary search vector 200d is shown composed of parameters P1′, P2′, P3′, . . . PN′. Much like the parameters of the vector 200c of FIG. 2C described above, each of the parameters P1′ through PN′ may have a value within the range of values for the respective parameter. As part of block 208b, each of the slave processors (e.g., the slave processor 206a and the slave processor 210a) may obtain/receive the search vector 200d from the communication bus 218a as represented via the reference character/component 210a-2 in FIG. 2A.

In block 212b, each of the slave processors may compute a parametric difference between the input/search vector obtained in block 208b and the vector stored by that processor (see, e.g., the storage device 210a-1 for the slave processor 210a in FIG. 2A) (potentially as part of block 204b). This computation of the difference for the slave processor 210a is represented by the component/reference character 210a-3 in FIG. 2A.

The computation of the difference in block 212b may result in a generation of a difference vector Vdiff. To demonstrate the generation of the difference vector Vdiff, and using the vectors 200c and 200d of FIGS. 2C-2D as an illustrative example, the difference vector Vdiff for the slave processor 210a may be computed/calculated as:

Vdiff=(P1′−P1)+(P1′−P1)+(P3′−P3)+ . . . (PN′−PN)

In block 216b, the master processor 202a may provide (via, e.g., the communication bus 218a), and the slave processors 206a and 210a may obtain/receive, parametric weights and/or a specification of one or more algorithms to use as represented by the component/reference character 210a-4 in FIG. 2A. For example, and for reasons that will become clearer below, the parametric weights may tend to emphasize a first parameter (or first parametric difference in accordance with the computation of the difference vector Vdiff described above in connection with block 212b), relative to a second parameter (or second parametric difference).

The parametric weights may take the form of a vector, such as for example the vector 200e shown in FIG. 2E. As shown in FIG. 2E, the vector 200e may include parametric weights W1, W2, W3, . . . WN. Each of the parametric weights W1 through WN may assume a value within a range of values.

The specification of the algorithm(s) in block 216b may include one or more formulas or operators to apply to the difference vector Vdiff computed as part of block 212b. For example, and referring to FIGS. 2C-2E, a weighted vector distance Vdist_weight may be computed as the square root of the weighted sum of the squares; e.g.:

Vdist_weight=square root[[W1*(P1′−P1)]\hat{ }2+[W2*(P2′−P2)]\hat{ }2+[W3*(P3′−P3)]\hat{ }2+ . . . [WN*(PN′−PN)]\hat{ }2],

where square root [arg] corresponds to an application of a square root function to the argument (arg) contained within the brackets [ ]

The application of the parametric weights and/or the algorithm(s) to compute, e.g., the weighted vector distance Vdist_weight, is shown in block 220b of FIG. 2B and is represented by component/reference character 210a-5 in FIG. 2A for the slave processor 210a.

The weighted vector distance Vdist_weight computed by a slave processor may represent the weighted distance of the vector stored by that slave processor relative to the input/search vector. For the sake of ease in comparison as described further below, the weighted vector distance Vdist_weight may be converted to a voltage as shown in block 224b of FIG. 2B and as represented by component/reference character 210a-6 for the slave processor 210a of FIG. 2A.

In some embodiments, and to the extent that the weighted distance vector Vdist_weight computed by block 220b is represented by/in a digital value/domain, the component 210a-6 may include a digital-to-analog converter (DAC) to convert the digital value/domain to an analog value/domain. Still further, the component 210a-6 may include/incorporate an inverter/inversion, such that a small-valued weighted vector distance Vdist_weight may result in a large-valued voltage being generated and output by the component 210a-6.

The respective voltages output by the slave processors (including, e.g., the voltage output by the component 210a-6 of the slave processor 210a) may be provided to, e.g., the voltage bus 222a as shown in FIG. 2A and as represented by block 228b in FIG. 2B.

The peak hold voltage bus/circuit 214a may be operatively coupled to the voltage bus 222a. For example, the peak hold voltage bus 214a may select and retain the maximum/peak voltage presented to the voltage bus 222a by the slave processors (e.g., slave processors 206a and 210a in FIG. 2A). In this respect, and as part of block 228b, the peak hold voltage bus 214a may include circuitry, such as for example one or more sample and hold circuits and/or one or more comparators, to facilitate the selection and retention of the maximum voltage.

In block 232b, the maximum voltage present on the peak hold voltage bus 214a (as obtained in block 228b) may be provided (e.g., echoed/rebroadcast) to each of the slave processors. In respect of the slave processor 210a, this provisioning of the maximum voltage is shown as a first input to the component/comparator 210a-7 in FIG. 2A. The second input to the component/comparator 210a-7 is the (local) voltage generated and output by the component 210a-6.

In block 236b, each slave processor may compare the maximum voltage obtained from the peak hold voltage bus 214a to the (local) voltage generated and output by the slave processor. For example, in connection with block 236b, the component/comparator 210a-7 may compare the maximum voltage obtained from the peak hold voltage bus 214a to the voltage generated and output by the component 210a-6. If the comparator 210a-7 detects a match based on the comparison, an output of the comparator 210a-7 may set an indicator, e.g., register A 210a-8 of the slave processor 210a as shown in block 240b. Otherwise, if the comparator 210a-7 does not detect a match based on the comparison, the output of the comparator 210a-7 may clear the register A 210a-8 as shown in block 244b (if the register A 210a-8 isn't cleared already).

The setting of the indicator/register A 210a-8 in block 240b may indicate that the slave processor 210a has the maximum voltage (or, analogously, the shortest weighted distance vector Vdist_weight) of all of the slave processors in the system. Conversely, the clearing of the indicator/register A 210a-8 in block 244b may indicate that the slave processor 210a does not have the maximum voltage (or, analogously, does not have the shortest weighted distance vector Vdist_weight) of all of the slave processors in the system.

Thus, as described above, each of the slave processors of the system independently determines, in parallel, whether that slave processor has the maximum voltage (or, analogously, the shortest weighted distance vector Vdist_weight). The execution of this determination in parallel provides significant savings in terms of time relative to a scenario where each of the slave processors is polled sequentially (e.g., as part of a linear searching algorithm) by, e.g., the master processor 202a, to identify the slave processor that has the maximum voltage.

Additionally, the system 200a and the method 200b are readily scalable in terms of adding/removing parameters to/from the vectors and/or adding/removing vectors/processors to/from the system, without any appreciable, additional time being added to/removed from the completion of the execution/operation of the system and method. In this respect, the system 200a and the method 200b may be used to accommodate both simplistic applications and complex applications without an appreciable difference in terms of the time taken to execute the applications.

Referring to FIGS. 2A-2B, the setting by a slave processor (e.g., slave processor 210a) of a register A (e.g., register A 210a-8) of the slave processor in block 240b may signify that the slave processor has data to report to the master processor 202a. From block 240b, flow may proceed to block 248b.

It is possible, and even likely, that in some embodiments there will be multiple slave processors that set their respective register A's as part of block 240b. Stated slightly differently, there may be multiple slave processors that contain/store respective vectors that, while potentially different from one another, qualify as the closest match (e.g., the shortest weighted distance) to the search/input vector. As described below, logic included in each of the slave processors shown in FIG. 2A may enable each slave processor that contains/stores the closest match to report the existence of that closest match to, e.g., the master processor 202a, in turn.

In addition to register A, each slave processor may include another (e.g., a second) register, e.g., a register B. For example, the slave processor 210a is shown in FIG. 2A as including a register B 210a-9. Except for the first slave processor, the value of register B for a given slave processor may correspond to the logical ‘OR’ of the register A value and the register B value of the preceding slave processor. For example, and as shown in FIG. 2A, the value of register B 210a-9 for the slave processor 210a may correspond to the logical ‘OR’ (as represented by the ‘OR’ gate 210a-10) of the value of register A 206a-8 of the slave processor 206a and the value of register B 206a-9 of the slave processor 206a. For reasons that will become clearer below, the first slave processor may have its register B (permanently) cleared/set equal to ‘0’, such that the first slave processor will be enabled to report its data when the first slave processor's register A is set equal to ‘1’.

Each slave processor may include another (e.g., a third) register, e.g., a register C. As represented in FIG. 2A, the value of register C (e.g., register C 210a-12) for a slave processor (e.g., slave processor 210a) may correspond to the logical ‘AND’ (as represented by the ‘AND’ gate 210a-11 for slave processor 210a) of the value of register A (e.g., register A 210a-8 for slave processor 210a) and an inverted (e.g., ‘NOT’) value of register B (e.g. register B 210a-9 for slave processor 210a) of that slave processor.

To demonstrate the impact/use of the logic just described, and as represented via reference character/component 210a-14 for slave processor 210a, register C for a given slave processor will be set (e.g., will be equal to ‘1’) only when the slave processor has data to report (as indicated when register A of the slave processor is set) and when all preceding slave processors do not have something to report (as indicated when register B of the slave processor is cleared). Otherwise, register C for the given slave processor will be cleared.

When register C for a given slave processor is set (e.g., is equal to ‘1’), that means that the slave processor is enabled to report the existence of the slave processor storing the closest match. Referring to FIG. 2B, in block 248b a slave processor may check to see if it's register C is set. If it is not (e.g., the “No” path is taken out of block 248b), flow may remain at block 248b to wait for register C to become set. Otherwise (e.g., the “Yes” path is taken out of block 248b), flow may proceed from block 248b to block 252b.

In block 252b, a slave processor may report/provide its data on, e.g., the communication bus 218a. The data reported by the slave processor in block 252b may be obtained/received by the master processor 202a (or another processor or device) as part of block 252b.

The data that is reported by the slave processor in block 252b may include an identifier of the slave processor (as represented by the component/storage device 210a-13 for the slave processor 210a). The identifier may uniquely distinguish the slave processor from the other slave processors in the system. The identifier may adhere to one or more addresses or addressing schemes in some embodiments. While shown separately in FIG. 2A, in some embodiments the storage device 210a-13 may correspond to the storage device 210a-1.

In some embodiments, the data that is reported by a slave processor in block 252b may include the vector stored by the slave processor (e.g., in the storage device 210a-1 in the case of the slave processor 210a). In some embodiments, the data that is reported by the slave processor might not include the vector stored by the slave processor. For example, the vector stored by the slave processor may be reported/provided to, e.g., the master processor 202a using out-of-band communications channels in order to minimize communications that occur over the communication bus 218a. Using an out-of-band communication technique as described above may enable the communication bus 218a to operate as a high-speed bus.

In some embodiments, the data that is reported in block 252b may include metadata associated with the vector stored by the slave processor. For example, assuming that a search that is performed is associated with a facial recognition application, the parameters of the vector stored by the slave processor may correspond to characteristics of a person identified in an image, and the metadata may include the image, the person's name, the person's residence or mailing address, the person's email address, the person's telephone number, etc.

From block 252b, flow may proceed to block 244b to cause a slave processor that just reported data (in block 244b) to clear its register A. The flow from block 252b to block 244b may cause the slave processor to hold its register A in a cleared state/condition for the duration of a reporting cycle and/or until a subsequent search is performed. As a result of a slave processor clearing its register A in conjunction with the flow from block 252b to block 244b, downstream slave processors may be enabled to report their data (assuming their respective register A's are set).

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In some embodiments, the method 200b may be executed a number of times to identify the closest ‘Z’ matches of vectors stored by the slave processors to the input/search vector. For example, the method 200b may be executed a first time to identify a first slave processor that stores/contains the closest match. In a subsequent execution of the method 200b (e.g., a second execution of the method 200b), the output of the first slave processor (e.g., the register C) may be disregarded/ignored (or, analogously, the register A of the first slave processor may be held in a cleared state), such that the second closest match is obtained in conjunction with the second execution of the method 200b. The process of ignoring slave processors may be repeated with each subsequent execution of the method 200b until the closest ‘Z’ matches are obtained.

Aspects of the disclosure may be utilized in connection with a large number of applications. For example, and as set forth above, aspects of the disclosure may be used in conjunction with facial/person identification/recognition applications. Aspects of the disclosure may also be utilized in conjunction with operations of vehicles, robotics, high-precision positioning of assets (e.g., space exploration), computer threat analytics (e.g., countering hacking), gaming (e.g., the playing/execution of video games), network management (e.g., resource utilization/allocation determinations), etc.

In some embodiments, parameters associated with a vector may correspond to static characteristics associated with an object, such as for example a coloring or pigmentation, a relative measure of hardness of the object, materials that compose the object, a specification of a shape/contour of the object, etc. In some embodiments, the parameters may correspond to dynamic characteristics that change over time, such as for example dynamic conditions or sequences (e.g., velocities or accelerations expressed over a period of time, changes in mass as a function of time, etc.).

Additionally, aspects of the disclosure may be directed to artificial intelligence and machine learning. To illustrate, and taking an exemplary application involving operations of a vehicle, it may be assumed that the driver of the vehicle is twenty-two years of age, that the vehicle is located in Scottsdale, Ariz., that the vehicle is travelling at 58 miles-per-hour (mph) in a 45 mph posted speed limit zone with a car 80 feet in front of the vehicle, a truck 73 feet behind the vehicle, and no cars on either side of the vehicle. Suddenly, a small dog may run out in front of the vehicle. These inputs (e.g., the age of the driver, the location in Scottsdale, the speed the vehicle is driving at, the posted speed limit, the distances and directions to the car and truck, the lack of cars on either side of the vehicle, the existence/location/speed of the dog, etc.) can all be represented as parameters (e.g., voltages) that are input to a master processor (e.g., master processor 202a of FIG. 2A) with updates at approximately 1000 times per second. The parameters may be at least partially obtained from supplemental sources. For example, a driving record of the driver may be obtained from a licensing board (e.g., a Department of Motor Vehicles (DMV)), police/court records, etc.

The master processer may share these parameters/inputs with the slave processors as a search/input vector, with any applicable weights as may be appropriate based on the application. The collective of the slave processors may then return metadata from a closely matching vector/condition within tens or hundreds of nanoseconds. The metadata may have been captured from historical events, thereby incorporating machine learning as part of this exemplary application. The metadata may provide instructional information to the vehicle (which could have been self-driving as well in some embodiments) that may, for instance, not only cause the brakes of the vehicle to be applied, but the brakes could be applied as appropriate to not cause the vehicle to hit the dog or the car in front and also not cause the truck to crash into (e.g., rear-end) the vehicle.

Aspects of the disclosure may incorporate X reality (XR) or cross reality technologies. As one skilled in the art will appreciate, XR or cross reality is a form of a mixed reality environment that comes from a fusion/union of ubiquitous sensor/actuator networks and shared online virtual worlds. XR technology may incorporate a wide spectrum of hardware, software, and/or firmware, and may include one or more sensory interfaces, applications, and/or infrastructures, that enable content creation/generation/provisioning for virtual reality (VR), augmented reality (AR), cinematic reality (CR), or a combination thereof. XR technology may be used to generate new or alternative forms of reality by incorporating objects (e.g., digital objects) into the physical world and may bring physical objects into the digital world. In this respect, XR technology may incorporate aspects of a mixed reality (MR), where traditional dividing lines between the physical world and the digital world are blended, obscured, or even eliminated. XR technology may incorporate visual/image data, audio data, or a combination thereof.

Aspects of the disclosure may be implemented in conjunction with one or more devices, such as for example network elements, servers, user devices, etc. For example, FIG. 2F is a block diagram illustrating a non-limiting embodiment of a headset 200f functioning as a user device in accordance with various aspects described herein. The headset 200f may be used to present one or more objects in accordance with XR technology. In some embodiments, the objects may be presented in conjunction with panoramic content (e.g., 360-degree videos).

Panoramic content may be recorded by omnidirectional cameras or camera array systems, and then “wrapped” onto at least a portion of a three-dimensional (3D) sphere (e.g., 3D sphere 202f), with the cameras at or proximate a center 204f of the sphere. When watching a panoramic video, a user/viewer at the spherical center 204f can freely control her viewing direction, so each playback may create a unique viewing experience. The control of viewing directions may be achieved through, e.g., head movement when using a head-mounted device, hand/finger movement when using a mobile/portable communication device (e.g., a phone or a tablet), a mouse click when using a laptop or desktop computer, or use of a remote control or trackball when using a display device such as a television. Other techniques, such as for example gesture recognition, may be used. One or more combinations of the controls described above may be used.

As shown in FIG. 2F, a headset 200f can be used to adjust a viewing orientation by changing the pitch, yaw, and/or roll, which correspond to movement (e.g., rotation) along the super-imposed X, Y, and Z axes, respectively. The headset 200f may support operations in accordance with six degrees/dimensions of freedom. For example, the X, Y, and Z axes collectively represent three dimensions of freedom, and movement along any one of the axes (e.g., in a plus or minus direction) represents another degree/dimension of freedom.

Panoramic video and game players may compute and display the viewing area based on the viewing orientation and the field of view (FoV). The FoV defines the extent of an observable area 208f, which may be a fixed or dynamic parameter of the headset 200f. In an illustrative embodiment, the observable area 208f may be 110° horizontally (+/−10%) and 90° vertically (+/−10%). Other values of the observable area 208f may be used in some embodiments, where the values may be dependent on an application that is being simulated or executed.

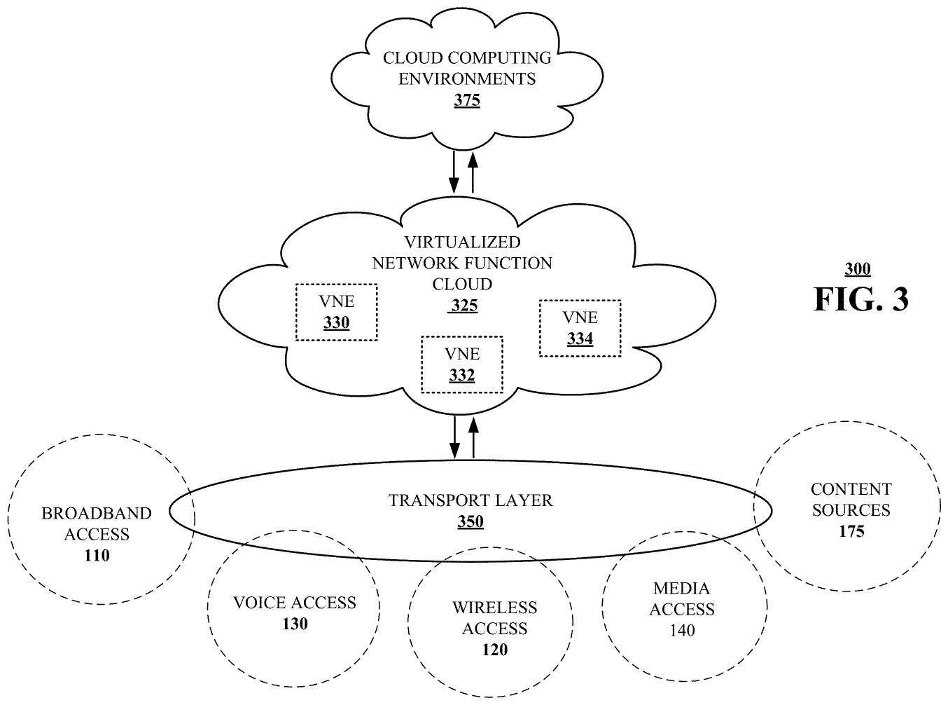

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of the system 200a, and the method 200b presented in FIGS. 1, 2A, and 2B. For example, virtualized communication network 300 can facilitate in whole or in part obtaining a first vector comprising a first plurality of parameters, wherein each parameter of the first plurality of parameters has a value within a range of values, determining a vector difference between the first plurality of parameters and a second plurality of parameters of a second vector, wherein each parameter of the second plurality of parameters has a value within the range of values, responsive to the determining, computing a first weighted vector distance based on the vector difference, providing a first representation of the first weighted vector distance to at least one bus, obtaining a second representation of a second weighted vector distance from the at least one bus, comparing the second representation of the second weighted vector distance to the first representation of the first weighted vector distance, and responsive to determining that the second representation of the second weighted vector distance matches the first representation of the first weighted vector distance based on the comparing, setting a first indicator to indicate a first match. Virtualized communication network 300 can facilitate in whole or in part providing a first vector to a plurality of processors, wherein each of the plurality of processors stores a respective secondary vector, and wherein the providing of the first vector causes each of the plurality of processors to compute a respective weighted vector distance based on the respective secondary vector and the first vector in accordance with an algorithm, and receiving, from at least one processor of the plurality of processors, an identification of the at least one processor of the plurality of processors, wherein the receiving of the identification is based on the at least one processor of the plurality of processors determining, based on the respective weighted vector distance computed by the at least one processor, that the respective secondary vector stored by the at least one processor is within a threshold distance of the first vector. Virtualized communication network 300 can facilitate in whole or in part computing in parallel, by each processor of a plurality of processors, a vector distance between a first vector that is received by the processor and a second vector that is stored by the processor, resulting in a plurality of vector distances, identifying a vector distance included in the plurality of vector distances that is the least, responsive to the identifying, determining in parallel, by each processor of the plurality of processors, whether the vector distance computed by the processor matches the vector distance included in the plurality of vector distances that is the least, and responsive to the determining, reporting by each processor of the plurality of processors an identification of the processor when the vector distance computed by the processor matches the vector distance included in the plurality of vector distances that is the least.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

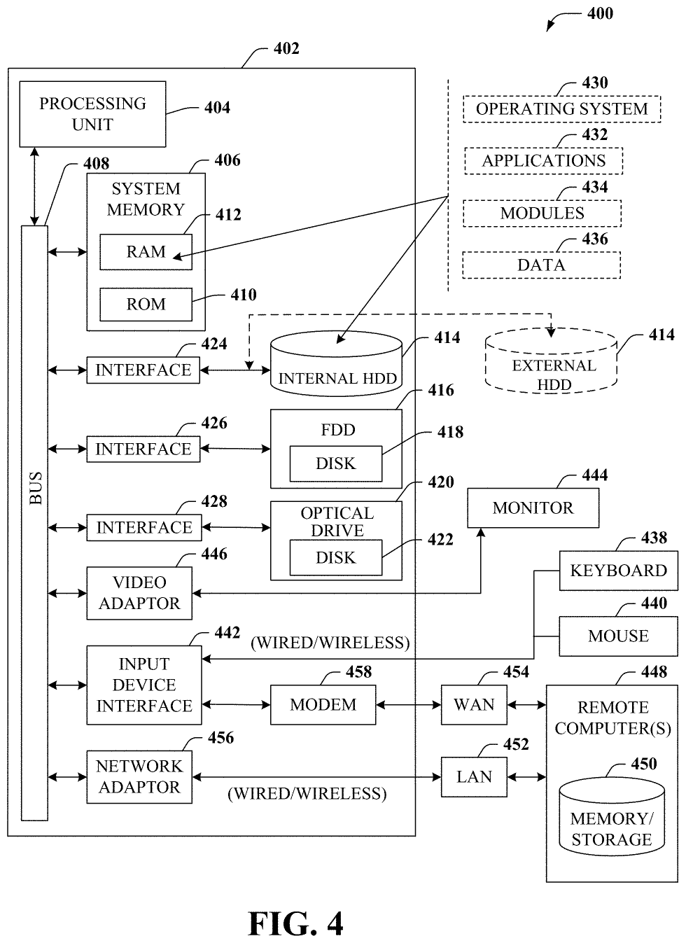

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part obtaining a first vector comprising a first plurality of parameters, wherein each parameter of the first plurality of parameters has a value within a range of values, determining a vector difference between the first plurality of parameters and a second plurality of parameters of a second vector, wherein each parameter of the second plurality of parameters has a value within the range of values, responsive to the determining, computing a first weighted vector distance based on the vector difference, providing a first representation of the first weighted vector distance to at least one bus, obtaining a second representation of a second weighted vector distance from the at least one bus, comparing the second representation of the second weighted vector distance to the first representation of the first weighted vector distance, and responsive to determining that the second representation of the second weighted vector distance matches the first representation of the first weighted vector distance based on the comparing, setting a first indicator to indicate a first match. Computing environment 400 can facilitate in whole or in part providing a first vector to a plurality of processors, wherein each of the plurality of processors stores a respective secondary vector, and wherein the providing of the first vector causes each of the plurality of processors to compute a respective weighted vector distance based on the respective secondary vector and the first vector in accordance with an algorithm, and receiving, from at least one processor of the plurality of processors, an identification of the at least one processor of the plurality of processors, wherein the receiving of the identification is based on the at least one processor of the plurality of processors determining, based on the respective weighted vector distance computed by the at least one processor, that the respective secondary vector stored by the at least one processor is within a threshold distance of the first vector. Computing environment 400 can facilitate in whole or in part computing in parallel, by each processor of a plurality of processors, a vector distance between a first vector that is received by the processor and a second vector that is stored by the processor, resulting in a plurality of vector distances, identifying a vector distance included in the plurality of vector distances that is the least, responsive to the identifying, determining in parallel, by each processor of the plurality of processors, whether the vector distance computed by the processor matches the vector distance included in the plurality of vector distances that is the least, and responsive to the determining, reporting by each processor of the plurality of processors an identification of the processor when the vector distance computed by the processor matches the vector distance included in the plurality of vector distances that is the least.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

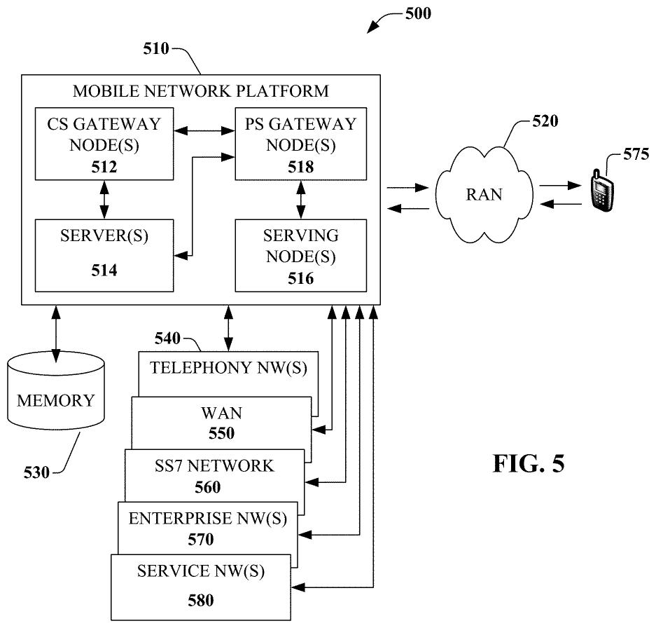

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining a first vector comprising a first plurality of parameters, wherein each parameter of the first plurality of parameters has a value within a range of values, determining a vector difference between the first plurality of parameters and a second plurality of parameters of a second vector, wherein each parameter of the second plurality of parameters has a value within the range of values, responsive to the determining, computing a first weighted vector distance based on the vector difference, providing a first representation of the first weighted vector distance to at least one bus, obtaining a second representation of a second weighted vector distance from the at least one bus, comparing the second representation of the second weighted vector distance to the first representation of the first weighted vector distance, and responsive to determining that the second representation of the second weighted vector distance matches the first representation of the first weighted vector distance based on the comparing, setting a first indicator to indicate a first match. Platform 510 can facilitate in whole or in part providing a first vector to a plurality of processors, wherein each of the plurality of processors stores a respective secondary vector, and wherein the providing of the first vector causes each of the plurality of processors to compute a respective weighted vector distance based on the respective secondary vector and the first vector in accordance with an algorithm, and receiving, from at least one processor of the plurality of processors, an identification of the at least one processor of the plurality of processors, wherein the receiving of the identification is based on the at least one processor of the plurality of processors determining, based on the respective weighted vector distance computed by the at least one processor, that the respective secondary vector stored by the at least one processor is within a threshold distance of the first vector. Platform 510 can facilitate in whole or in part computing in parallel, by each processor of a plurality of processors, a vector distance between a first vector that is received by the processor and a second vector that is stored by the processor, resulting in a plurality of vector distances, identifying a vector distance included in the plurality of vector distances that is the least, responsive to the identifying, determining in parallel, by each processor of the plurality of processors, whether the vector distance computed by the processor matches the vector distance included in the plurality of vector distances that is the least, and responsive to the determining, reporting by each processor of the plurality of processors an identification of the processor when the vector distance computed by the processor matches the vector distance included in the plurality of vector distances that is the least.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

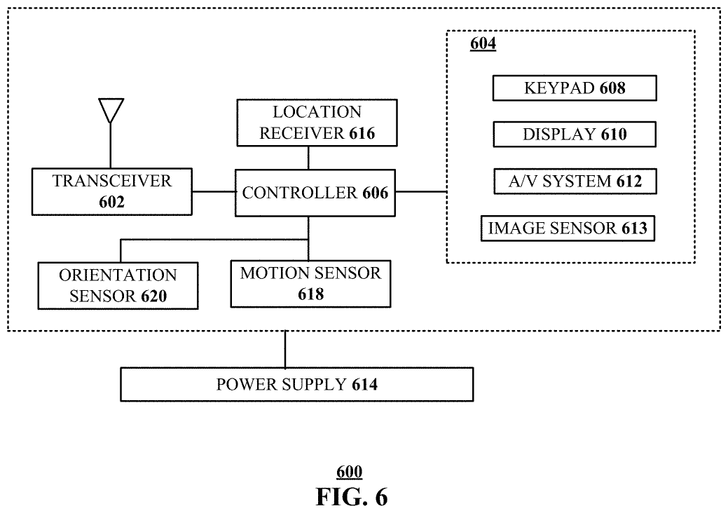

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part obtaining a first vector comprising a first plurality of parameters, wherein each parameter of the first plurality of parameters has a value within a range of values, determining a vector difference between the first plurality of parameters and a second plurality of parameters of a second vector, wherein each parameter of the second plurality of parameters has a value within the range of values, responsive to the determining, computing a first weighted vector distance based on the vector difference, providing a first representation of the first weighted vector distance to at least one bus, obtaining a second representation of a second weighted vector distance from the at least one bus, comparing the second representation of the second weighted vector distance to the first representation of the first weighted vector distance, and responsive to determining that the second representation of the second weighted vector distance matches the first representation of the first weighted vector distance based on the comparing, setting a first indicator to indicate a first match. Computing device 600 can facilitate in whole or in part providing a first vector to a plurality of processors, wherein each of the plurality of processors stores a respective secondary vector, and wherein the providing of the first vector causes each of the plurality of processors to compute a respective weighted vector distance based on the respective secondary vector and the first vector in accordance with an algorithm, and receiving, from at least one processor of the plurality of processors, an identification of the at least one processor of the plurality of processors, wherein the receiving of the identification is based on the at least one processor of the plurality of processors determining, based on the respective weighted vector distance computed by the at least one processor, that the respective secondary vector stored by the at least one processor is within a threshold distance of the first vector. Computing device 600 can facilitate in whole or in part computing in parallel, by each processor of a plurality of processors, a vector distance between a first vector that is received by the processor and a second vector that is stored by the processor, resulting in a plurality of vector distances, identifying a vector distance included in the plurality of vector distances that is the least, responsive to the identifying, determining in parallel, by each processor of the plurality of processors, whether the vector distance computed by the processor matches the vector distance included in the plurality of vector distances that is the least, and responsive to the determining, reporting by each processor of the plurality of processors an identification of the processor when the vector distance computed by the processor matches the vector distance included in the plurality of vector distances that is the least.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining a first vector comprising a first plurality of parameters, wherein each parameter of the first plurality of parameters has a value within a range of values;
determining a vector difference between the first plurality of parameters and a second plurality of parameters of a second vector that is stored by the device, wherein each parameter of the second plurality of parameters has a value within the range of values;
responsive to the determining, computing a first weighted vector distance based on the vector difference;
providing a first representation of the first weighted vector distance to at least one bus;
obtaining a second representation of a second weighted vector distance from the at least one bus;
comparing the second representation of the second weighted vector distance to the first representation of the first weighted vector distance; and
responsive to determining that the second representation of the second weighted vector distance matches the first representation of the first weighted vector distance based on the comparing, setting a first indicator to indicate a first match.

2. The device of claim 1, wherein the operations further comprise:
obtaining the second vector from the at least one bus; and
storing the second vector in the memory.

3. The device of claim 1, wherein the operations further comprise:
obtaining a plurality of parametric weights from the at least one bus,
wherein the computing of the first weighted vector distance is further based on the plurality of parametric weights.

4. The device of claim 3, wherein the computing of the first weighted vector distance comprises applying a square root function to a summation of squares of parameters of the vector distance multiplied by respective parametric weights of the plurality of parametric weights.

5. The device of claim 1, wherein the providing of the first representation of the first weighted vector distance to at least one bus comprises providing a first voltage corresponding to the first weighted vector distance to the at least one bus.

6. The device of claim 5, wherein the operations further comprise:
inverting the first weighted vector distance to generate a first inverted weighted vector distance; and
generating the first voltage based on the first inverted weighted vector distance.

7. The device of claim 5, wherein the obtaining of the second representation of the second weighted vector distance from the at least one bus comprises obtaining a second voltage from the at least one bus.

8. The device of claim 7, wherein the comparing of the second representation of the second weighted vector distance to the first representation of the first weighted vector distance comprises comparing the second voltage to the first voltage.

9. The device of claim 1, wherein the operations further comprise:
receiving a second indication from a second device that indicates that the second device, a third device, or a combination thereof, has detected a second match with respect to the second representation of the second weighted vector distance.

10. The device of claim 9, wherein the operations further comprise:
subsequent to receiving the second indication, receiving a third indication from the second device that the second device, the third device, or the combination thereof, has reported the second match on the at least one bus; and
providing an indication of the first match to the at least one bus responsive to the receiving of the third indication.

11. The device of claim 10, wherein the first indicator comprises a register, and wherein the operations further comprise:
clearing the register subsequent to the providing of the indication of the first match to the at least one bus.

12. The device of claim 10, wherein the providing of the indication of the first match comprises providing an identifier of the device, a copy of the second vector, metadata associated with the second vector, or a combination thereof.

13. A machine-readable medium, comprising executable instructions that, when executed by a processing system including a processor, facilitate performance of operations, the operations comprising:
providing a first vector to a plurality of secondary processors, wherein each of the plurality of secondary processors stores a respective secondary vector, and wherein the providing of the first vector causes each of the plurality of secondary processors to compute a respective weighted vector distance based on the respective secondary vector stored by the secondary processor and the first vector in accordance with an algorithm; and
receiving, from at least one processor of the plurality of secondary processors, an identification of the at least one processor of the plurality of secondary processors, wherein the receiving of the identification is based on the at least one processor of the plurality of secondary processors determining, based on the respective weighted vector distance computed by the at least one processor, that the respective secondary vector stored by the at least one processor is within a threshold distance of the first vector.

14. The machine-readable medium of claim 13, wherein the operations further comprise:
providing a plurality of parametric weights to the plurality of secondary processors,
wherein the providing of the plurality of parametric weights causes each of the plurality of second processors to compute the respective weighted vector distance in accordance with the plurality of parametric weights.

15. The machine-readable medium of claim 13, wherein the operations further comprise:
receiving, from the at least one processor of the plurality of secondary processors, a copy of the respective secondary vector stored by the at least one processor, metadata associated with the respective secondary vector stored by the at least one processor, or a combination thereof; and
processing the copy of the respective secondary vector stored by the at least one processor, the metadata associated with the respective secondary vector stored by the at least one processor, or the combination thereof, in accordance with an application executed by the processing system.

16. A method comprising:
computing in parallel, by each processor of a plurality of processors, a vector distance between a first vector that is received by the processor and a second vector that is stored by the processor, resulting in a plurality of vector distances;
identifying a vector distance included in the plurality of vector distances that is the least;
responsive to the identifying, determining in parallel, by each processor of the plurality of processors, whether the vector distance computed by the processor matches the vector distance included in the plurality of vector distances that is the least; and
responsive to the determining, reporting by each processor of the plurality of processors an identification of the processor when the vector distance computed by the processor matches the vector distance included in the plurality of vector distances that is the least.

17. The method of claim 16, further comprising:
inverting in parallel, by each processor of the plurality of processors, the vector distance computed by the processor, resulting in a plurality of inverted distances; and
converting in parallel, by each processor of the plurality of processors, the inverted distance for the processor to a voltage, resulting in a plurality of voltages,
wherein the identifying of the vector distance included in the plurality of vector distances that is the least comprises identifying a voltage included in the plurality of voltages that is the greatest.

18. The method of claim 17, wherein the identification of the processor comprises parameters of the second vector stored by the processor.

19. The method of claim 16, wherein the plurality of processors correspond to separate threads executed by a common processing core.

20. The method of claim 16, wherein the plurality of processors correspond to discrete components that are each housed within separate housings.
